(19) United States
(12) Patent Application Publication
(10) Pub. No.: US 2014/0032079 A1
(43) Pub. Date: Jan. 30, 2014

(54) DIAGNOSTIC AND CONTROL SYSTEM AND METHOD

(71) Applicants: Anil VARMA, Clifton Park, NY (US); Bret Dwayne WORDEN, Erie, PA (US); Nicholas Edward RODDY, Schenectady, NY (US); Feng XUE, Clifton Park, NY (US); Bendict George LANDER, Lawrence Park, PA (US); Gregory W. WOLZ, Wattsburg, PA (US)

(72) Inventors: Anil VARMA, Clifton Park, NY (US); Bret Dwayne WORDEN, Erie, PA (US); Nicholas Edward RODDY, Schenectady, NY (US); Feng XUE, Clifton Park, NY (US); Bendict George LANDER, Lawrence Park, PA (US); Gregory W. WOLZ, Wattsburg, PA (US)

(21) Appl. No.: 13/558,435

(22) Filed: Jul. 26, 2012

(51) Int. Cl. G01M 15/05; G01M 17/00; G06F 15/00

(52) U.S. Cl. 701/101; 702/183; 701/29.1

(57) ABSTRACT

Systems and methods for diagnosing or prognosing mobile and/or fixed client assets in a logical and interactive manner. Embodiments of the present invention provide a data analyzer with one or more asset diagnostic models. An asset diagnostic model is configured to logically and systematically interact with a client asset and analyze operational parameter data obtained from the client asset to diagnose a problem with the client asset and/or to predict or forecast future problems or conditions of the client asset.

### BACKGROUND

1. Technical Field

Embodiments of the subject matter disclosed herein relate to mobile and/or fixed client assets. Other, embodiments of the subject matter disclosed herein relate to methods and systems for diagnosing or prognosing mobile and/or fixed client assets.

2. Discussion of Art

The fields of diagnostics and prognostics for client assets are almost exclusively dominated by applications in which very specific capabilities are investigated, such as for one class of failures, one client asset, or one sub-system of a client asset. Work has been mainly targeted to and focused on anomaly detection systems for an individual client asset, or an individual sub-system of a particular client asset. Managing assets can be difficult, and the approach of servicing assets at regular time intervals often results in the assets being over-serviced.

### BRIEF DESCRIPTION

Systems and methods for diagnosing or prognosing mobile and/or fixed client assets are disclosed. A set of data is initially collected from a client asset, such as performance operation data collected during client asset operation. The set of data is analyzed to determine additional data that may be desirable to collect from the client asset and analyze in order to make a final diagnosis and/or prognosis for the client asset. Embodiments of the present invention provide a data analyzer with one or more asset diagnostic models or sets of instructions. An asset diagnostic model is configured to logically and systematically interact with a client asset and analyze operational parameter data obtained from the client asset to diagnose a problem with the client asset and/or to predict or forecast future problems or conditions of the client asset.

In one embodiment, a method is provided. The method includes receiving first operational parameter data from an asset data collection system associated with a client asset. The method also includes processing the first operational parameter data to generate first diagnostic data. The method further includes analyzing the first diagnostic data to generate a trigger event of a diagnostic request, and communicating the diagnostic request to the asset data collection system. The first operational parameter data may include one or more of engine speed, torque output, water temperature, engine temperature, air compressor pressure, oil pressure, hydraulic fluid pressure, signal strength, battery life, or battery state-of-charge of the client asset. The diagnostic request may include a control system command to put the client asset in a determined operating state. The determined operating state may include at least one of a particular gear of the client asset, a braking mode of the client asset, an idle mode of the client asset, a full horsepower mode of the client asset, a communication mode of the client asset, or a backup power mode of the client asset. The diagnostic request may further include information to command the asset data collection system to capture second operational parameter data from the client asset during the determined operating state. The second operational parameter data may include one or more of engine speed, torque output, water temperature, engine temperature, air compressor pressure, oil pressure, hydraulic fluid pressure, signal strength, battery life, or battery state-of-charge of the client asset during the determined operating state. The method may further include receiving the second operational parameter data from the asset data collection system of the client asset, analyzing the second operational parameter data, and generating diagnostic results based on the analysis of the second operational parameter data. The diagnostic request may include information which commands the asset data collection system to receive a data capture logic of the asset data collection system for capturing second operational parameter data. The diagnostic request may include at least one algorithm object, selected based on the analysis of the first diagnostic data, that is configured to be executed by the asset data collection system. The at least one algorithm object may be programmed to perform a data reduction process, when executed by the asset data collection system, on second operational parameter data captured by the asset data collection system. The at least one algorithm object may be programmed to perform a data compression process, when executed by the asset data collection system, on second operational parameter data captured by the asset data collection system.

In one embodiment, a method is provided. The method includes receiving first operational parameter data from an asset data collection system associated with a client asset and processing the first operational parameter data that is received to generate first diagnostic data. The method further includes, based on a trigger event determined in association with the first diagnostic data, communicating a diagnostic request to the asset data collection system. The method also includes receiving second operational parameter data, that is generated responsive to the diagnostic request, from the asset data collection system, and generating diagnostic results of the client asset based at least in part on the second operational parameter data. The method may further include, responsive to the diagnostic request, the asset data collection system controlling at least one subsystem of the client asset to a steady state while varying operation of at least one second subsystem of the client asset. The method may also include the asset data collection system generating the second operational parameter data at least partially based on the controlling.

In one embodiment, a system is provided. The system includes a data analyzer having at least one computer and a non-transitory computer readable medium accessible by the computer. The data analyzer is Configured for communication with an asset data collection system associated with a client asset. The data analyzer is operable to receive first operational parameter data from the asset data collection system. The non-transitory computer readable medium contains one or more sets of diagnostic instructions that, when executed by the computer, cause the computer to process the first operational parameter data to generate first diagnostic data and selectively generate a trigger event, and communicate a diagnostic request to the data collection system in response to the trigger event. The diagnostic instructions may be further configured, when executed by the computer, to cause the computer to receive second operational parameter data captured by the asset data collection system in response to the diagnostic request, analyze the second operational parameter data, and generate diagnostic results based at least in part on the analysis of the second operational parameter data. The diagnostic request may be configured, when acted upon by at least one of the asset data collection system or a control system of the client asset, to put the client asset in a determined operating state during which the second operational parameter data is captured. The data analyzer may be located remotely from the client asset and may be configured to receive the first operational parameter data from the client asset that is a mobile client asset.

In one embodiment, a system is provided. The system includes an asset data collection system associated with at least one client asset and operable to capture first operational parameter data of the at least one client asset: The system also includes a data analyzer having at least one computer hosting at least one asset diagnostic model in communication with the asset data collection system, wherein the asset data collection system is operable to communicate the first operational parameter data to the data analyzer. The at least one asset diagnostic model is operable to receive the first operational parameter data from the asset data collection system, process the first operational parameter data to generate first diagnostic data and selectively generate a trigger event, and communicate a diagnostic request to the asset data collection system in response to the trigger event. The asset data collection system may be further operable to capture second operational parameter data of the client asset and communicate the second operational parameter data to the data analyzer in response to the diagnostic request. The at least one diagnostic model may be further operable to receive the second operational parameter data from the asset data collection system, analyze the second operational parameter data, and generate diagnostic results based on at least the analysis of the second operational parameter data. The system may also include a control system associated with the at least one client asset and in operative communication with the asset data collection system, wherein the control system is operable to put the at least one client asset in a determined operating state in response to the diagnostic request. The asset data collection system may include a data capture logic for capturing the first operational parameter data and may be operable to reconfigure the data capture logic for capturing second operational parameter data in response to the diagnostic request. The at least one asset diagnostic model of the data analyzer may be further operable to select at least one algorithm object in response to the trigger event and include the at least one algorithm object in the diagnostic request communicated to the asset data collection system, wherein the at least one algorithm object is configured to be executed by the asset data collection system. The at least one client asset may be a mobile client asset and may be one of a locomotive, mining equipment, industrial equipment, or a military vehicle providing the first operational parameter data that is representative of at least one of water temperature, air compressor pressure, engine speed, or torque output. The at least one client asset may be a mobile client asset and may be a marine vessel providing the first operational parameter data that is representative of at least one of engine temperature or oil pressure. The at least one client asset may be a mobile client asset and may be an aircraft providing the first operational parameter data that is representative of hydraulic fluid pressure. The at least one client asset may be a mobile client asset and may be one of a portable communication device or a portable data device providing the first operational parameter data that is representative of at least one of signal strength or battery life. The at least one client asset may be a fixed client asset including at least one of a power generating station, a water treatment center, a data center, a telecommunication station, or a computer asset.

### BRIEF DESCRIPTION OF THE DRAWINGS

Reference is made to the accompanying drawings in which particular embodiments of the invention are illustrated as described in more detail in the description below, in which:

FIG. 1 is an illustration of a first exemplary embodiment of a system for logically obtaining operational parameter data from a client asset and analyzing the data to determine a diagnosis or a prognosis for the client asset;

FIG. 2 is an illustration of a second exemplary embodiment of a system for logically obtaining operational parameter data from a client asset and analyzing the data to determine a diagnosis or a prognosis for the client asset;

FIG. 3 is an illustration of an exemplary embodiment of a data analyzer used in the systems of FIG. 1 and FIG. 2; and

FIG. 4 illustrates a flow chart of an exemplary embodiment of a method for logically obtaining operational parameter data from a client asset and analyzing the data to determine a diagnosis or a prognosis for the client asset using the system of FIG. 1 or FIG. 2.

### DETAILED DESCRIPTION

Embodiments of the present invention relate to methods and systems for diagnosing or prognosing mobile and/or fixed client assets. A set of data is initially collected from a client asset, such as performance operation data collected during client asset operation. The set of data is analyzed to determine additional data that may be desirable to collect from the client asset and analyze in order to make a final diagnosis and/or prognosis for the client asset.

With reference to the drawings, like reference numerals designate identical or corresponding parts throughout the several views. However, the inclusion of like elements in different views does not mean a given embodiment necessarily includes such elements or that all embodiments of the invention include such elements.

The term “client asset” as used herein means a fixed asset or a mobile asset that is owned and/or operated by a client entity such as, for example, a railroad, a power generation company, a mining equipment company, an airline, or any other asset-owning and/or asset-operating entity.

The term “operational parameter data” as used herein means values or data corresponding to performance operation information collected from client asset operation, maintenance records, periodical inspection data (e.g., oil samples taken from a locomotive), or incidents generated by control systems on-board a client asset.

The term “sampled” as used herein means read, sensed, measured, captured, or collected when referring to operational parameter data or operational parameter values.

The term “asset diagnostic model” as used herein means a computer program, computer instructions, logic circuitry, or some equivalent thereof used for determining a diagnosis and/or prognosis of a client asset.

The term “data capture logic” as used herein means a computer program, a portion of a computer program, logic circuitry, or some equivalent thereof used for acquiring particular operational parameter data from a client asset in a particular manner.

The term “algorithm object” as used herein means a computer program, a portion of a computer program, or some equivalent thereof, provided by a data analyzer to a client asset, and which is executed on an asset data collection system of the client asset to operate on operational parameter data acquired by the asset data collection system.

The term “data reduction process” as used herein means a method for eliminating unwanted or redundant data from a set of operational parameter data.

The term “data compression process” as used herein means a method for putting a set of operational parameter data in a compact form without significantly losing information.

The term “data condensing process” is used generally herein and may refer to a data reduction process, a data compression process, or both.

The terms “diagnosis” and “prognosis” (and the various forms thereof) may be used interchangeably herein and refer to an identification of a problem of a client asset and/or a forecast of a condition or a future problem of a client asset.

The term “hosting” is used generally herein to refer to a computer having an executable program or set of computer instructions residing thereon. For example, a data analyzer may have a computer hosting an asset diagnostic model (i.e., the asset diagnostic model is an executable computer program or set of computer instructions residing in a memory of the computer of the data analyzer).

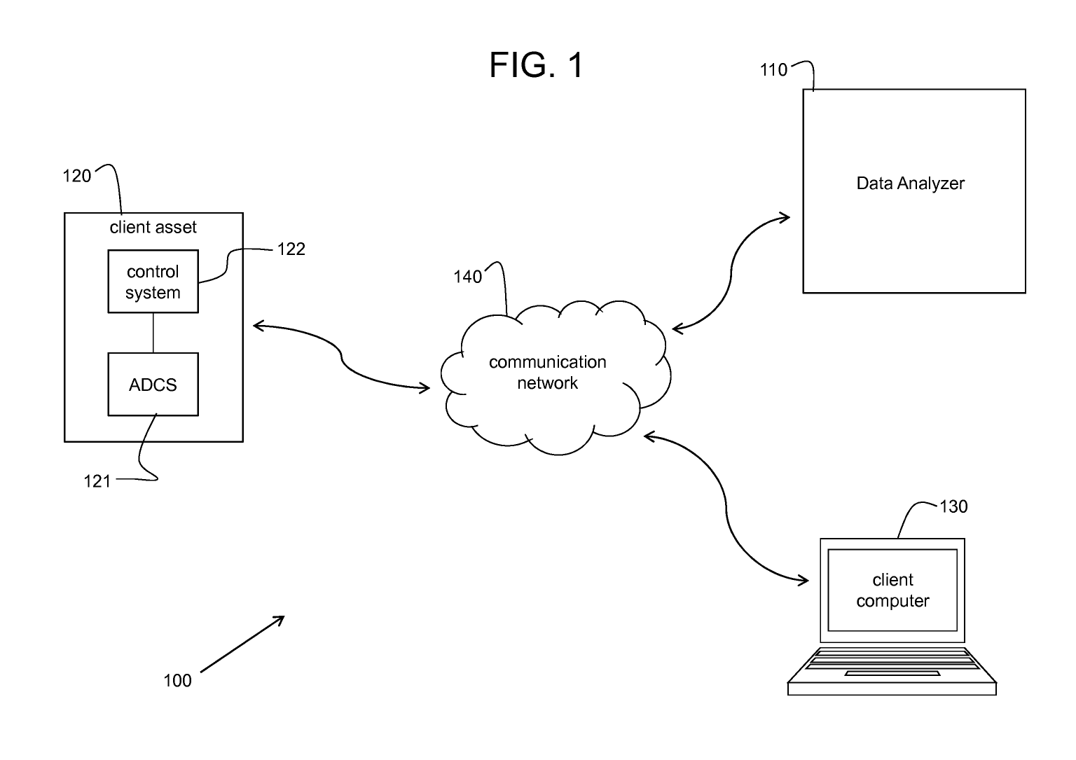

FIG. 1 is an illustration of a first exemplary embodiment of a system 100 for logically obtaining operational parameter data from a client asset and analyzing the data to determine a diagnosis or a prognosis for the client asset. The system 100 includes a data analyzer 110 and a client asset 120. The client asset 120 includes an asset data collection system (ADCS) 121 and a control system 122. The client asset may be, for example, a locomotive belonging to a railroad client. The system 100 may also include a client computer 130 such as, for example, a personal laptop computer.

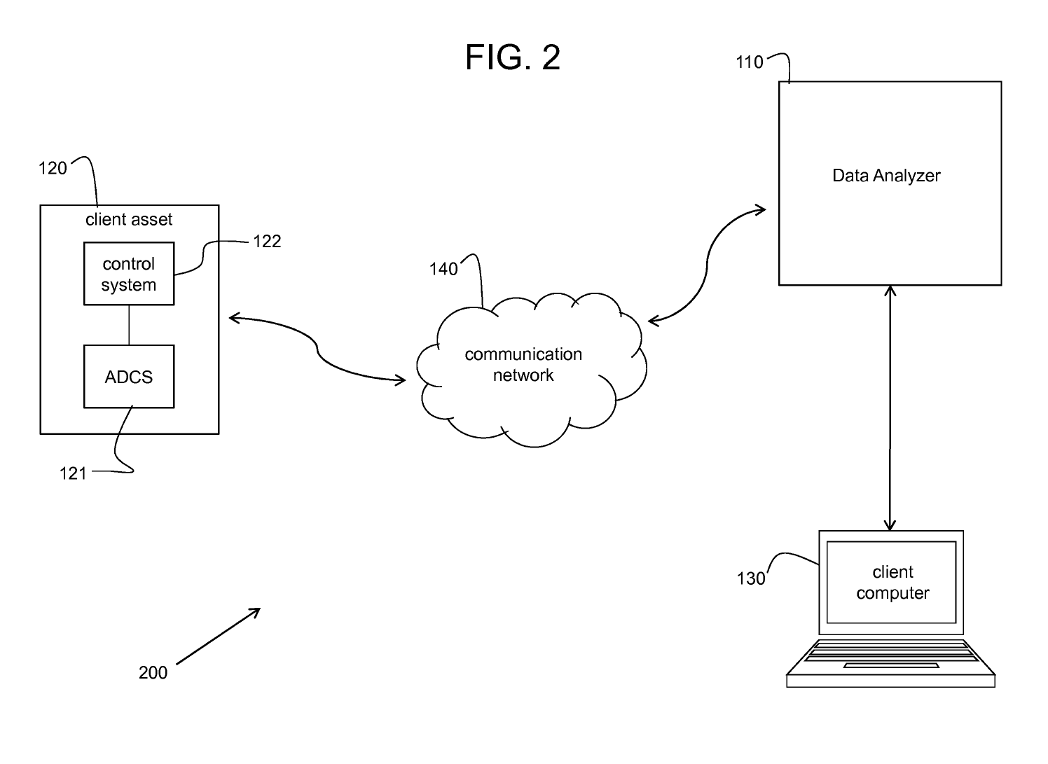

FIG. 2 is an illustration of a second exemplary embodiment of a system 200 for logically obtaining operational parameter data from a client asset and analyzing the data to determine a diagnosis or a prognosis for the client asset. In FIG. 2, the client computer 130 is directly connected to the data analyzer 110 (i.e., the data analyzer 110 and the client computer 120 are co-located).

The client asset 120 has various sensors for sampling various operational parameters of the client asset 120. The sensors may include, for example, pressure sensors, speed sensors, voltage sensors, current sensors, and temperature sensors. Other types of sensors are possible as well, in accordance with various embodiments. The operational parameter data is sampled by the sensors at the command of the ADCS 121, in accordance with an embodiment.

In accordance with an embodiment of the present invention, the client asset 120 and the data analyzer 110 communicate with each other via a communication network 140. The client computer 130 and the data analyzer 110 also communicate with each other via the communication network 140 (see FIG. 1). In embodiments, one or more of the data analyzer 110, the client asset 120, and/or the client computer 130 are remotely located with respect to each other. In such embodiments, the communication network 140 may include a wide area network (WAN) having, for example, one or more of the internet, a cellular communication system, and a satellite communication system. Such a WAN allows communication between a client asset 120 in the field and the data analyzer 110 that is remotely located at, for example, a central facility. The client computer 130 may be in the field or at some other facility, for example.

In other embodiments, where the elements of the system 100 are located more proximate to each other, the communication network 140 may include a local area network (LAN) such as, for example, an Ethernet-based LAN or a Wi-Fi-based LAN. For example, the client asset 120 may be located on one side of a facility and the data analyzer 110 and the client computer 130 may be located on the other side of the facility. Still, in other embodiments where the elements of the system 100 are located very proximate to each other, the communication network 140 may be simplified to a direct communication connection between the system elements. For example, the client asset 120, the data analyzer 110, and the client computer 130 may all be co-located in a same room of a facility.

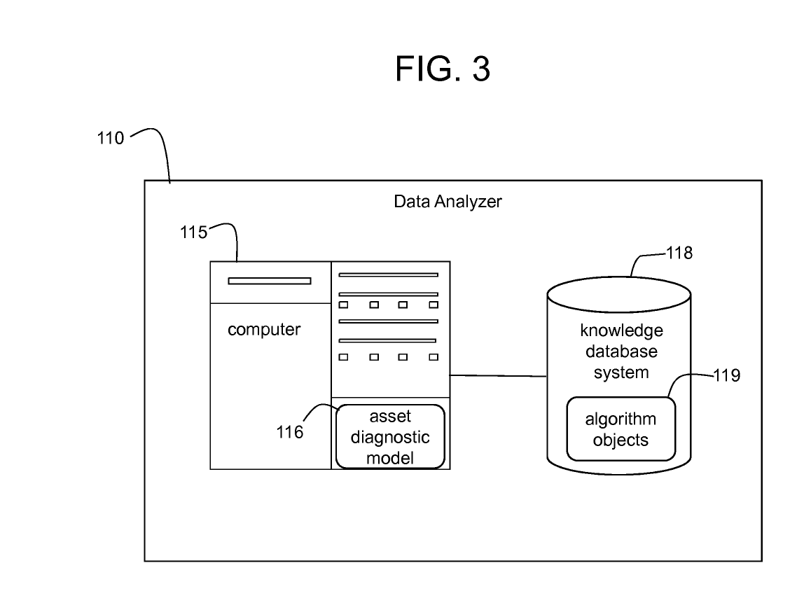

FIG. 3 is an illustration of an exemplary embodiment of a data analyzer 110 used in the systems 100 and 200 of FIG. 1 and FIG. 2. The data analyzer 110 includes a computer 115 communicatively connected to a knowledge database system 118. The computer 115 hosts an asset diagnostic model 116 in the form of software instructions for performing the methods described herein for diagnosing and/or prognosing mobile and/or fixed client assets in a logical and interactive manner. However, in accordance with other embodiments, as defined above, the asset diagnostic model may be a computer program, logic circuitry, or some equivalent thereof used for determining a diagnosis and/or prognosis of a client asset.

The knowledge database system 118 may be used to store client asset information that can be used by the asset diagnostic model 116 to diagnose a client asset 120. Such client asset information may include knowledge with respect to normal operation of the client asset, operational relationships between client asset sub-systems and/or performance parameters, and algorithm objects 119 configured to, for example, condense operational parameter data at the client asset.

In accordance with an embodiment of the present invention, the data analyzer 110 is configured as a software-as-a service (SaaS) product provided by a service provider, which is accessible by an authorized client via a client computer 130 through the communication network 140. For example, the data analyzer 110 may allow a client to access a web page of a server computer 115 over the internet 140 via a client computer 130. Through a user interface provided by the web page, the client can direct the data analyzer 110 to acquire operational parameter data from a client asset 120, process the operational parameter data to generate diagnostic data, analyze the diagnostic data to generate a trigger event of a diagnostic request, and communicate the diagnostic request back to the client asset to, for example, gather additional operational parameter data which can be used by the data analyzer 110 to refine a diagnosis. The SaaS configuration may provide services to a plurality of different clients for various types of client assets, for example.

In accordance with another embodiment of the present invention, the data analyzer 110 is configured to be installed at a client facility for use only by that client. The data analyzer 110 may be customized for that particular client and the type of client assets owned and/or operated by the client. The client may access the data analyzer 110 from a client computer 130 via a LAN within the client facility, or via a direct communication connection between the client computer 130 and the computer 115. In such an embodiment, the data analyzer 110 does not function as a server to service, for example, multiple clients. Instead, the data analyzer 110 is dedicated to a particular client and a particular client asset or group of client assets, for example.

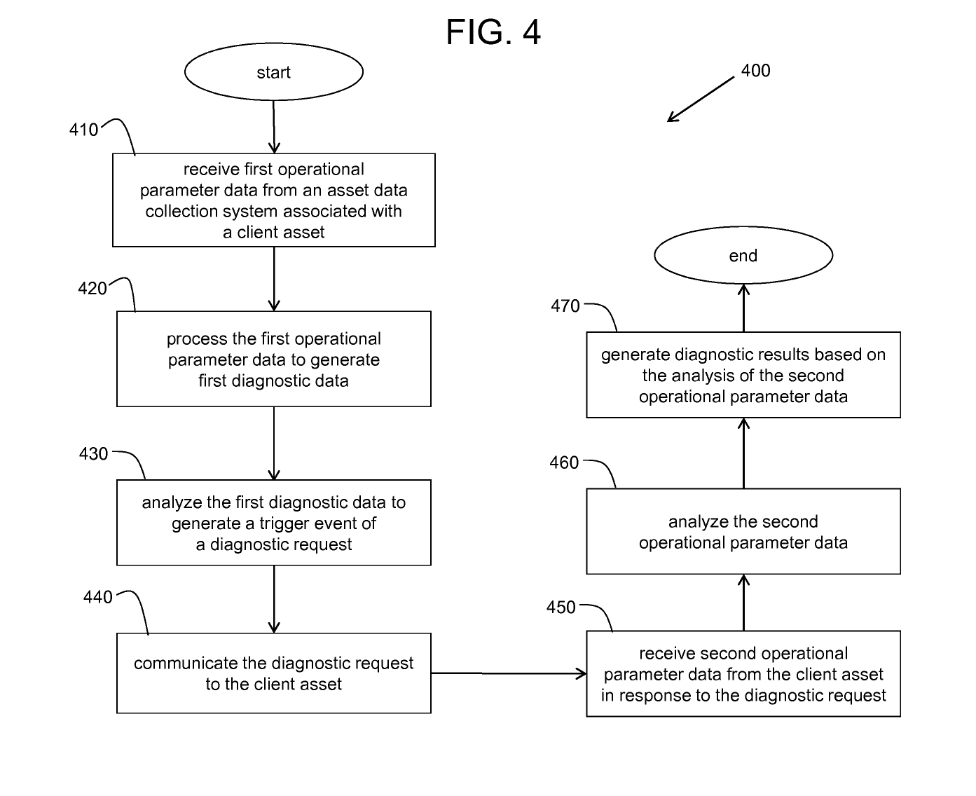

FIG. 4 illustrates a flow chart of an exemplary embodiment of a method 400 for logically obtaining operational parameter data from a client asset and analyzing the data to determine a diagnosis or a prognosis for the client asset using the system 100 of FIG. 1 or 200 of FIG. 2. In step 410 of the method 400, first operational parameter data are received from an asset data collection system associated with a client asset, or at the command of a user via the client computer 130. The first operational parameter data may be sampled by the client asset as part of a periodic or continuous monitoring process for the client asset. The operational parameter data may be transmitted from the ADCS 121 of the client asset 120 to the data analyzer 110 via the communication network 140, for example.

Client assets may be fixed or mobile. For example, if the client asset is a locomotive, the operational parameter data may be numerical values related to operational parameters including engine speed, torque output, water temperature, and air compressor pressure of the locomotive. If the client asset is a marine vessel, the operational parameter data may be numerical values related to operational parameters including engine temperature and oil pressure, for example.

Other types of client assets are possible as well. For example, a mobile client asset may be one of a mining equipment, industrial equipment, or a military vehicle providing operational parameter data representative of at least one of water temperature, air compressor pressure, engine speed, or torque output. Another mobile client asset may be an aircraft providing operational parameter data representative of hydraulic fluid pressure, for example. A further mobile client asset may be a portable communication device or a portable data device providing operational parameter data representative of at least one of signal strength, battery life, or battery state-of-charge, for example. Examples of fixed client assets include a power generating station, a water treatment center, a data center, a telecommunication station, or a computer asset.

In step 420 of the method 400, the first operational parameter data is processed to generate first diagnostic data The first diagnostic data may provide an initial indication of a problem with the client asset, but may not fully identify the problem and/or the source of the problem. Therefore, in step 430 of the method 400, the first diagnostic data is analyzed to generate a trigger event in the form of a diagnostic request. In general, the diagnostic request is a request for additional operational parameter data (e.g., second operational parameter data) to be provided by the client asset, and may also indicate how the additional data is to be sampled and processed by the client asset before being provided.

For example, the diagnostic request may indicate, via a control system command, that the client asset is to be put in a particular operating state before sampling the additional operational parameter data. The particular operating state may include, for example, one of a particular gear of the client asset, a braking mode of the client asset, an idle mode of the client asset, a full horsepower mode of the client asset, a communication mode of the client asset, or a backup power mode of the client asset. Other operating states are possible as well, depending on the client asset. In accordance with an embodiment, the control system 122 of the client asset 120 puts the client asset 120 in a particular operating state in response to the diagnostic request.

In accordance with an embodiment, the ADCS 121 includes a data capture logic in the form of a computer program, a portion of a computer program, logic circuitry, or some equivalent thereof, and is used for acquiring particular operational parameter data from a client asset in a particular manner. The diagnostic request may include instructions which communicate to the ADCS 121 how to revise, modify, or reconfigure its data capture logic to aid in acquiring second operational parameter data. For example, the diagnostic request may direct the ADCS 121 to revise its data capture logic to sample certain operational parameter data at a certain rate over a certain period of time, and provide that operational parameter data to the data analyzer 110 as second operational parameter data.

In accordance with another embodiment, the diagnostic request may include an algorithm object 119 which is a computer program, a portion of a computer program, or some equivalent thereof, which is executed on the ADCS 121 of the client asset 120 to operate on, for example, second operational parameter data acquired by the ADCS 121. The algorithm object 119 may perform a data condensing process on the second operational parameter data such as, for example, a data reduction process or a data compression process. Such a data condensing process may be desirable to perform at the client asset 120 in order to reduce the overall amount of data to be communicated to the data analyzer 110 without sacrificing a significant amount of information. The reduced amount of data may result in a savings of cost, time, and bandwidth use associated with the communication network 140. In accordance with an embodiment, an algorithm object 119 to be included in a diagnostic request is selected by the asset diagnostic model 115 from the knowledge database system 118 based on an analysis of the first diagnostic data

In step 440 of the method 400, the diagnostic request is communicated to the client asset. For example, the data analyzer 110 may communicate the diagnostic request to the client asset 120 via the communication network 140. In accordance with an embodiment, the diagnostic request is received by the ADCS 121 of the client asset. The ADCS 121 reads the diagnostic request and proceeds to acquire second operational parameter data in response to the diagnostic request. Again, the diagnostic request may indicate how the additional data is to be sampled and processed by the client asset 120 before being provided to the data analyzer 110.

In step 450 of the method 400, the second operational parameter data is received from the client asset in response to the diagnostic request. In accordance with an embodiment, the second operational parameter data is sent from the ADCS 121 of the client asset 120 to the data analyzer 110 via the communication network 140. The second operational parameter data includes additional information to be analyzed by the data analyzer 110.

In step 460 of the method 400, the second operational parameter data is analyzed and in step 470 of the method 400, diagnostic results are generated based on the analysis of the second operational parameter data In accordance with an embodiment, the second operational parameter data includes additional information that the data analyzer 110 may use to reline a diagnosis or prognosis over that of what could be achieved by analyzing the first operational parameter data. As part of the analysis, the data analyzer 110 may use one or more asset diagnostic models 116 along with information from the knowledge database system 118 to generate the diagnostic results. In accordance with an embodiment, an authorized user may review the diagnostic results on the data analyzer 110 via the client computer 130, for example.

As an example, the client asset 120 is a locomotive and the first operational parameter data, as processed by the data analyzer 110 to form diagnostic data, indicates that the engine of the locomotive does not seem to be running as efficiently as expected. The unexpected inefficiency of the locomotive engine results in a trigger event within the data analyzer 110 of generating a diagnostic request that is sent to the ADCS 121 of the locomotive. The diagnostic request includes instructions for the ADCS 121 of the locomotive to sample and collect second operational parameter data including engine speed, engine temperature, and torque output when the engine of the locomotive is in a full horsepower mode. In accordance with an embodiment, the computer 115 of the data analyzer 110 accesses information from the knowledge database system 118 of the data analyzer 110 as part of determining which second operational parameters to sample in which operating state.

The ADCS 121 communicates with the control system 122 to tell the control system 122 to put the engine in a full horsepower mode. Corresponding sensors associated with the locomotive engine then sample engine speed, engine temperature, and torque output as second operational parameter data and provides the second operational parameter data to the ADCS 121. The ADCS 121 then sends the second operational parameter data to the data analyzer 110 for analysis.

The computer 115 of the data analyzer 110 processes the second operational parameter data by applying an appropriate asset diagnostic model 116 to the data, along with other related information obtained by the computer 115 from the knowledge database system 118. An asset diagnostic model 116 may include, for example, one or more functions or algorithms derived from or employing neural network techniques, evolutionary algorithm techniques (e.g., genetic algorithm techniques), maximum likelihood techniques, or other predictive algorithm techniques. In accordance with the present example, the data analyzer 110 may determine that the engine of the locomotive has a malfunctioning piston cylinder which is the diagnostic result.

In another embodiment, a method (e.g., diagnostics methods) comprises receiving first operational parameter data from an asset data collection system associated with a client asset. (The first operational parameter data may be received at a location remote from the asset data collection system and/or client asset.) The method further comprises processing the operational parameter data that is received to generate first diagnostic data. Based on a trigger event determined in association with the first diagnostic data, the method further comprises communicating a diagnostic request to the asset data collection system, and receiving second operational parameter data that is generated responsive to the diagnostic request, from the asset data collection system. The method further comprises generating diagnostics results of the client asset based at least in part on the second operational parameter data

In another embodiment of the method, the method further comprises, responsive to the diagnostic request, the asset data collection system controlling at least one first subsystem of the client asset to a steady state while varying operation of at least one second subsystem of the client asset. The method further comprises the asset data collection system generating the second operational parameter data at least partially based on the step of controlling the at least one first subsystem and the at least one second subsystem That is, the second operational parameter data is data sensed or otherwise generated of the client asset in operation with the at least one first subsystem in a steady state while operation of the at least one second subsystem is varied. Subsystem refers to a portion of the client asset that is controllable separately from at least one other portion.

Another embodiment relates to a system (e.g., diagnostics system) comprising a data analyzer having at least one computer and a non-transitory computer readable storage medium accessible by the computer. The data analyzer is configured for communication with an asset data collection system associated with a client asset, e.g., at a location remote from the data analyzer. The data analyzer is operable to receive first operational parameter data from the asset data collection system. The storage medium contains one or more sets of diagnostics instructions that when executed by the computer cause the computer to: process the first operational parameter data to generate first diagnostic data and selectively generate a trigger event; and communicate a diagnostic request to the asset data collection system in response to the trigger event.

In another embodiment, the diagnostics instructions are further configured, when executed by the computer, to cause the computer to receive second operational parameter data captured by the asset data collection system in response to the diagnostic request. That is, the asset data collection system generates the second operational parameter data responsive to the diagnostic request, and communicates it to the data analyzer. The diagnostics instructions are further configured, when executed by the computer, to cause the computer to analyze the second operational parameter data, and generate diagnostic results based at least in part on the analysis of the second operational parameter data.

In another embodiment, the diagnostic request is configured, when acted upon by at least one of the asset data collection system or a control system of the client asset, to put the client asset in a determined operating state during which the second operational parameter data is captured.

In another embodiment, the data analyzer is located remotely from the client asset, and the data analyzer is configured to receive the first operational parameter data from the client asset that is a mobile client asset.

In appended claims, the terms “including” and “having” are used as the plain language equivalents of the term “comprising”; the term “in which” is equivalent to “wherein.” Moreover, in appended claims, the terms “first,” “second,” “third,” “upper,” “lower,” “bottom,” “top,” etc. are used merely as labels, and are not intended to impose numerical or positional requirements on their objects. Further, the limitations of the appended claims are not written in means-plus-function format and are not intended to be interpreted based on 35 U.S.C. §112, sixth paragraph, unless and until such claim limitations expressly use the phrase “means for” followed by a statement of function void of further structure. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A method comprising:
receiving first operational parameter data from an asset data collection system associated with a client asset;
processing the first operational parameter data to generate first diagnostic data;
analyzing the first diagnostic data to generate a trigger event of a diagnostic request; and
communicating the diagnostic request to the asset data collection system.

2. The method of claim 1, wherein the first operational parameter data includes one or more of engine speed, torque output, water temperature, engine temperature, air compressor pressure, oil pressure, hydraulic fluid pressure, signal strength, battery life, or battery state-of-charge of the client asset

3. The method of claim 1, wherein the diagnostic request includes a control system command to put the client asset in a determined operating state.

4. The method of claim 3, wherein the determined operating state includes at least one of a particular gear of the client asset, a braking mode of the client asset, an idle mode of the client asset, a full horsepower mode of the client asset, a communication mode of the client asset, or a backup power mode of the client asset.

5. The method of claim 3, wherein the diagnostic request further includes information to command the asset data collection system to capture second operational parameter data from the client asset during the determined operating state.

6. The method of claim 5, wherein the second operational parameter data includes one or more of engine speed, torque output, water temperature, engine temperature, air compressor pressure, oil pressure, hydraulic fluid pressure, signal strength, battery life, or battery state-of-charge of the client asset during the determined operating state.

7. The method of claim 5, further comprising:
receiving the second operational parameter data from the asset data collection system of the client asset;
analyzing the second operational parameter data; and
generating diagnostic results based on the analysis of the second operational parameter data.

8. The method of claim 1, wherein the diagnostic request includes information which commands the asset data collection system to revise a data capture logic of the asset data collection system for capturing second operational parameter data

9. The method of claim 1, wherein the diagnostic request includes at least one algorithm object, selected based on the analysis of the first diagnostic data, that is configured to be executed by the asset data collection system.

10. The method of claim 9, wherein the at least one algorithm object is programmed to perform a data reduction process, when executed by the asset data collection system, on second operational parameter data captured by the asset data collection system.

11. The method of claim 9, wherein the at least one algorithm object is programmed to perform a data compression process, when executed by the asset data collection system, on second operational parameter data captured by the asset data collection system.

12. A method comprising:
receiving first operational parameter data from an asset data collection system associated with a client asset;
processing the first operational parameter data that is received to generate first diagnostic data;
based on a trigger event determined in association with the first diagnostic data, communicating a diagnostic request to the asset data collection system;
receiving second operational parameter data that is generated responsive to the diagnostic request, from the asset data collection system; and
generating diagnostics results of the client asset based at least in part on the second operational parameter data.

13. The method of claim 12, further comprising:
responsive to the diagnostic request, the asset data collection system controlling at least one subsystem of the client asset to a steady state while varying operation of at least one second subsystem of the client asset; and
the asset data collection system generating the second operational parameter data at least partially based on the controlling.

14. A system comprising:
a data analyzer having at least one computer and a non-transitory computer readable medium accessible by the computer, wherein the data analyzer is configured for communication with an asset data collection system associated with a client asset, wherein the data analyzer is operable to receive first operational parameter data from the asset data collection system, and wherein the non-transitory computer readable medium contains one or more sets of diagnostics instructions that when executed by the computer, cause the computer to:
process the first operational parameter data to generate first diagnostic data and selectively generate a trigger event; and
communicate a diagnostic request to the data collection system in response to the trigger event.

15. The system of claim 14, wherein the diagnostics instructions are further configured, when executed by the computer, to cause the computer to receive second operational parameter data captured by the asset data collection system in response to the diagnostic request, analyze the second operational parameter data, and generate diagnostic results based at least in part on the analysis of the second operational parameter data.

16. The system of claim 14, wherein the diagnostic request is configured, when acted upon by at least one of the asset data collection system or a control system of the client asset, to put the client asset in a determined operating state during which the second operational parameter data is captured.

17. The system of claim 14, wherein the data analyzer is located remotely from the client asset, and the data analyzer is configured to receive the first operational parameter data from the client asset that is a mobile client asset.

18. A system comprising:
an asset data collection system associated with at least one client asset and operable to capture first operational parameter data of the at least one client asset;
a data analyzer having at least one computer hosting at least one asset diagnostic model in communication with the asset data collection system, wherein the asset data collection system is operable to communicate the first operational parameter data to the data analyzer, and wherein the at least one asset diagnostic model is operable to:
receive the first operational parameter data from the asset data collection system;
process the first operational parameter data to generate first diagnostic data and selectively generate a trigger event; and
communicate a diagnostic request to the asset data collection system in response to the trigger event.

19. The system of claim 18, wherein the asset data collection system is further operable to capture second operational parameter data of the client asset and communicate the second operational parameter data to the data analyzer in response to the diagnostic request.

20. The system of claim 19, wherein the at least one asset diagnostic model is further operable to receive the second operational parameter data from the asset data collection system, analyze the second operational parameter data, and generate diagnostic results based on at least the analysis of the second operational parameter data.

21. The system of claim 18, further comprising a control system associated with the at least one client asset and in operative communication with the asset data collection system, wherein the control system is operable to put the at least one client asset in a determined operating state in response to the diagnostic request.

22. The system of claim 18, wherein the asset data collection system includes a data capture logic for capturing the first operational parameter data and is operable to reconfigure the data capture logic for capturing second operational parameter data in response to the diagnostic request.

23. The system of claim 18, wherein the at least one asset diagnostic model of the data analyzer is further operable to select at least one algorithm object in response to the trigger event and include the at least one algorithm object in the diagnostic request communicated to the asset data collection system, wherein the at least one algorithm object is configured to be executed by the asset data collection system.

24. The system of claim 18, wherein the at least one client asset is a mobile client asset.

25. The system of claim 24, wherein the mobile client asset is one of a locomotive, mining equipment, industrial equipment, or a military vehicle providing the first operational parameter data, and wherein the first operational parameter data is representative of at least one of water temperature, air compressor pressure, engine speed, or torque output.

26. The system of claim 24, wherein the mobile client asset is a marine vessel providing the first operational parameter data, and wherein the first operational parameter data is representative of at least one of engine temperature or oil pressure.

27. The system of claim 24, wherein the mobile client asset is an aircraft providing the first operational parameter data, and wherein the first operational parameter data is representative of hydraulic fluid pressure.

28. The system of claim 24, wherein the mobile client asset is one of a portable communication device or a portable data device providing the first operational parameter data, and wherein the first operational parameter data is representative of at least one of signal strength or battery life.

29. The system of claim 18, wherein the at least one client asset is a fixed client asset.

30. The system of claim 29, wherein the fixed client asset includes at least one of a power generating station, a water treatment center, a data center, a telecommunication station, or a computer asset.
